(19) United States
(12) Patent Application Publication
(10) Pub. No.: US 2018/0084131 A1
(43) Pub. Date: Mar. 22, 2018

(54) CLIENT DEVICE, PORTABLE TERMINAL, AND NON-TRANSITORY COMPUTER READABLE MEDIUM

(71) Applicant: FUJI XEROX CO., LTD., Tokyo (JP)

(72) Inventor: Takayuki HASHIMOTO, Kanagawa (JP)

(73) Assignee: FUJI XEROX CO., LTD., Tokyo (JP)

(21) Appl. No.: 15/444,666

(22) Filed: Feb. 28, 2017

(30) Foreign Application Priority Data
Sep. 20, 2016 (JP) 2016-182797

(51) Int. Cl. H04N 1/00; G06F 3/0482; G06F 1/16

(52) U.S. Cl. CPC H04N 1/00973; G06F 3/0482; G06F 1/1613; H04N 1/00204; H04N 2201/0075; H04N 2201/0082; H04N 2201/0039; H04N 2201/0055; H04N 1/00307

(57) ABSTRACT

A client device includes a supply section that supplies guide screen information to a specified device in response to selection of a specific type of paper, the guide screen information representing a guide screen related to supply of the paper to a printer, and a transmitting section that transmits print data to the printer.

### CROSS-REFERENCE TO RELATED APPLICATIONS

This application is based on and claims priority under 35 USC 119 from Japanese Patent Application No. 2016-182797 filed Sep. 20, 2016.

### BACKGROUND

### Technical Field

The present invention relates to a client device, a portable terminal, and a non-transitory computer readable medium.

### SUMMARY

According to an aspect of the invention, there is provided a client device including a supply section that supplies guide screen information to a specified device in response to selection of a specific type of paper, the guide screen information representing a guide screen related to supply of the paper to a printer, and a transmitting section that transmits print data to the printer.

### BRIEF DESCRIPTION OF THE DRAWINGS

Exemplary embodiment of the present invention will be described in detail based on the following figures wherein:

FIG. 1 illustrates a general arrangement according to an exemplary embodiment;

FIG. 2 illustrates the hardware configuration of a client device;

FIG. 3 illustrates the hardware configuration of a portable terminal;

FIG. 4 illustrates the hardware configuration of a printer;

FIG. 5 is a block diagram illustrating a functional configuration related to a guide screen display process;

FIG. 6 is a flowchart of a guide screen display process;

FIG. 7 illustrates a first guide screen;

FIG. 8 illustrates a device selection screen;

FIG. 9 is a sequence diagram of a first example of step E01;

FIG. 10 is a sequence diagram of a second example of step E01;

FIG. 11 is a sequence diagram of a first example of step D01;

FIG. 12 is a sequence diagram of a second example of step D01;

FIG. 13 is a sequence diagram of a third example of step D01;

FIG. 14 is a sequence diagram of a first example of step C01;

FIG. 15 is a sequence diagram of a second example of step C01;

FIG. 16 is a sequence diagram of a third example of step C01; and

FIG. 17 is a sequence diagram of an example of step B01.

### DETAILED DESCRIPTION

An exemplary embodiment of the present invention will be described below.

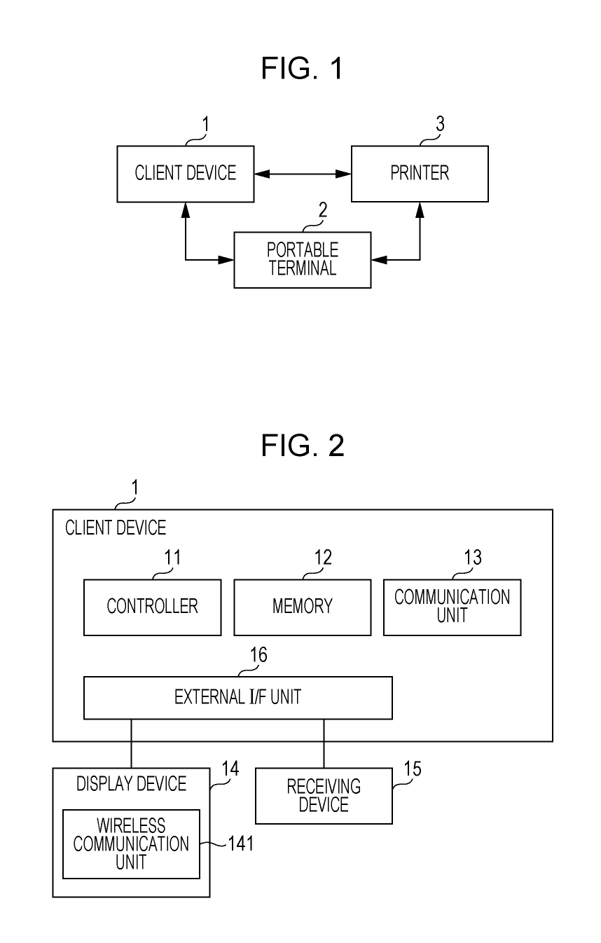

FIG. 1 illustrates a general arrangement according to an exemplary embodiment. A client device 1 and a printer 3 are connected to a local area network (LAN). The LAN is provided with a wireless LAN access point. A portable terminal 2 communicates with the client device 1 and the printer 3 via wireless LAN. The client device 1 is, for example, a personal computer (to be referred to as PC hereinafter), such as a desktop or notebook PC. The portable terminal 2 is, for example, a tablet PC or a smart phone.

FIG. 2 illustrates the hardware configuration of the client device 1. A controller 11 includes an arithmetic unit such as a central processing unit (CPU), and storage devices such as a read only memory (ROM) and a random access memory (RAM). The ROM stores firmware describing the procedure for activating hardware or an operating system (OS). The RAM stores data used when the CPU executes an arithmetic operation. A memory 12 includes a hard disk storage device, a semiconductor memory, or other storage devices, and stores information such as an OS or an application program. A communication unit 13 represents a communication interface (I/F) for connecting the client device 1 to a LAN.

An external I/F unit 16 is connected with a display device 14, and a receiving device 15. The display device 14 is, for example, a liquid crystal display device. The display device 14 displays a graphical user interface (GUI) screen or other information used by the operator to operate the client device 1. The receiving device 15 is, for example, a keyboard or a pointing device. The receiving device 15 receives an operation made by the operator, and outputs a signal corresponding to the operation to the controller 11. One or both of the display device 14 and the receiving device 15 may be integrated with the client device 1.

The client device 1 also doubles as a tablet PC. Specifically, the client device 1 includes, as pointing devices, a mouse, and a touch panel disposed so as to cover the display surface of the display device 14. The touch panel receives an operation such as a tap, a flick, or a drag, and outputs a signal corresponding to the operation to the controller 11. The client device 1 operates in one of a desktop mode and a tablet mode. The desktop mode is a mode that displays a screen used to perform operations with a mouse and a keyboard. The tablet mode is a mode that displays a screen used to perform operations with a touch panel. A wireless communication unit 141 included in the display device 14 is a communication I/F for connecting the display device 14 to a wireless LAN.

If the client device 1 is of a notebook type, the display device 14 is removable from the body of the client device 1. When the display device 14 is removed from the client device 1, the communication between the display device 14 and the client device 1 is performed via wireless LAN. If the client device 1 is of a desktop type, the display device 14 and the body of the client device 1 are connected by a communication cable. At this time, when the communication cable is removed, the communication between the display device 14 and the client device 1 is performed via wireless LAN. That is, when the client device 1 is switched to the tablet mode, and the display device 14 is separated from the body of the client device 1, the display device 14 functions as a tablet PC. If the client device 1 is of a notebook type, depending on its size or weight, the client device 1 provides a portability equivalent to that of a tablet PC even when the display device is not separated from the body. In such a case as well, the display device 14 functions as a tablet PC.

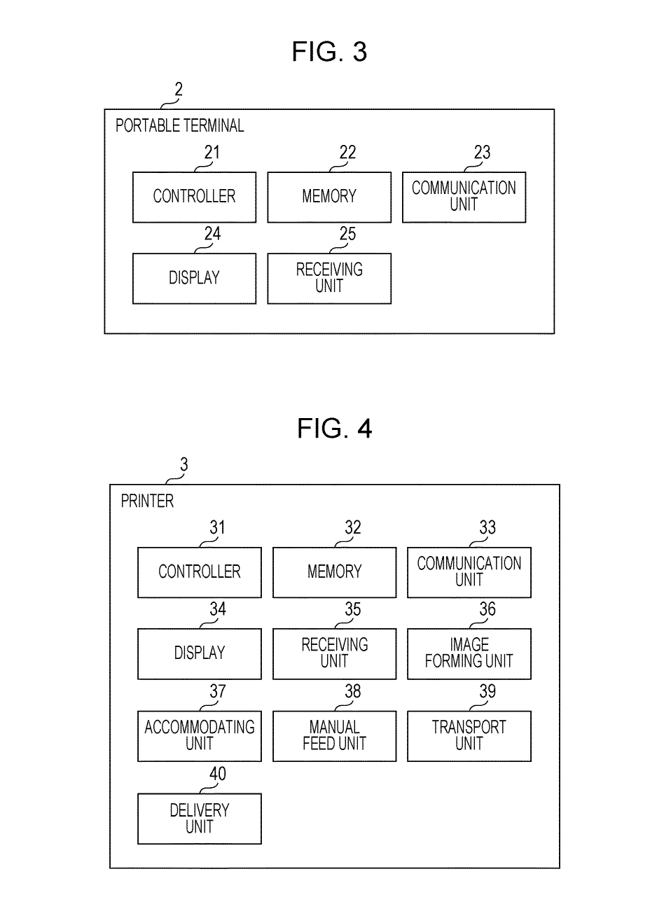

FIG. 3 illustrates the hardware configuration of the portable terminal 2. A controller 21 includes an arithmetic unit such as a CPU, and storage devices such as a ROM and a RAM. The ROM stores firmware describing the procedure for activating hardware or an operating system (OS). The RAM stores data used when the CPU executes an arithmetic operation. A memory 22 includes, for example, a semiconductor memory, and stores an OS or an application program. A communication unit 23 is a communication I/F for connecting the portable terminal 2 to a wireless LAN access point. The portable terminal 2 may be provided with components such as a communication I/F for connecting the portable terminal 2 to the communication network of cellular phones, and a speaker, microphone, or voice processing circuit used for telephone conversation.

A display 24 is, for example, a liquid crystal display device, and displays a GUI screen used for the user to operate the portable terminal 2. A receiving unit 25 is, for example, a touch panel disposed so as to cover the display surface of the display 24. The receiving unit 25 receives an operation such as a tap, a flick, or a drag, and outputs a signal corresponding to the operation to the controller 21.

FIG. 4 illustrates the hardware configuration of the printer 3. A controller 31 includes an arithmetic unit such as a CPU, and storage devices such as a ROM and a RAM. The ROM stores firmware describing the procedure for activating hardware or an operating system (OS). The RAM stores data used when the CPU executes an arithmetic operation. A memory 32 includes, for example, a hard disk storage device or a semiconductor memory, and stores information such as an OS or an application program. A communication unit 33 is a communication I/F for connecting the printer 3 to a LAN.

A display 34 is, for example, a liquid crystal display device, and displays a GUI screen used for the user to operate the printer 3. A receiving unit 35 is, for example, a touch panel disposed so as to cover the display surface of the display 34. The touch panel receives an operation such as a tap, a flick, or a drag, and outputs a signal corresponding to the operation to the controller 31. An image forming unit 36 forms an image on a medium based on raster data. The image forming unit 36 may employ any system such as the electrophotographic system or inkjet system.

Printing media are roughly divided into plain paper and special paper. Plain paper refers to printing paper compliant with, for example, the Japanese Industrial Standards (JIS). Examples of special paper include envelopes, postcards, labels, and heavy paper. An accommodating unit 37 is, for example, a drawer type box that accommodates a stack of plain paper. A manual feed unit 38 has, for example, a plate-like component that projects from an opening provided in a side surface of the printer. A stack of special paper or plain paper is manually placed on the top surface of this component. A transport unit 39 includes a transport path that extends from the accommodating unit 37 and the manual feed unit 38 to a delivery unit 40 via the image forming unit 36. The transport unit 39 draws a medium sheet by sheet from the accommodating unit 37 or the manual feed unit 38, transports the medium to the image forming unit 36, and transports the medium with an image formed thereon by the image forming unit 36 to the delivery unit 40.

A program describing the procedure for a process related to display of a guide screen described later (to be referred to as guide screen display process hereinafter) is installed in the client device 1.

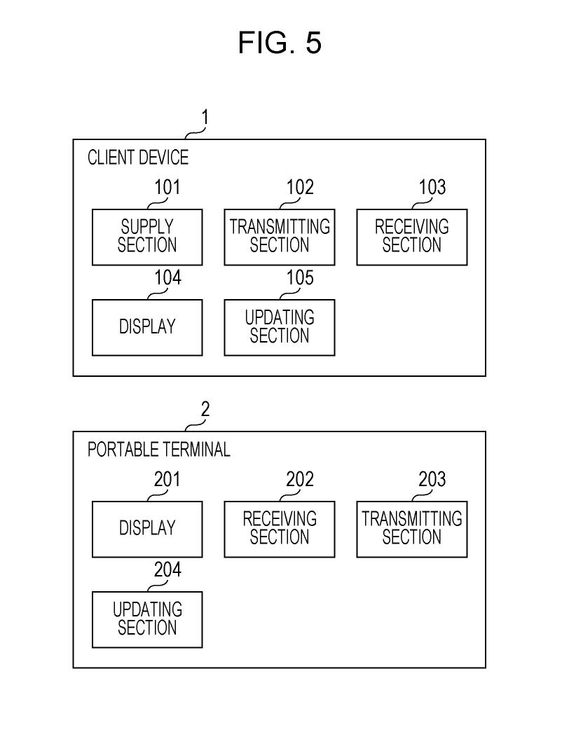

FIG. 5 is a block diagram illustrating a functional configuration related to the guide screen display process. A supply section 101 supplies guide screen information to a specified device in response to selection of a special type of paper. The guide screen information represents a guide screen related to supply of the paper to a printer. A transmitting section 102 transmits print data to the printer. A receiving section 103 displays device candidates to which the guide screen information is supplied, and receives a selection of a device to which the guide screen information is supplied. The supply section 101 supplies the guide screen information to the device selected by using the receiving section 103. A display 104 displays, when the client device 1 is selected by using the receiving section 103, a guide screen based on the guide screen information, and a print setting screen that receives a change to a print setting. An updating section 105 updates the guide screen in accordance with the setting changed on the print setting screen. The guide screen represented by the guide screen information is a screen used to perform operations with a touch panel.

A display 201 receives, from the client device, guide screen information, which represents a guide screen related to supply of a specific type of paper to the printer, and displays a guide screen based on the received guide screen information. A receiving section 202 receives a change to a print setting. A transmitting section 203 transmits print setting information representing the changed setting to the client device or the printer. An updating section 204 updates the guide screen in accordance with the changed print setting. How this process is specifically performed will be described below.

Now, an event that triggers the guide screen display process will be described. For example, the controller 11 of the client device 1 executes an application, and a screen for operating the application is displayed on the display device 14. The application used at this time may be any application, such as a document-editing application, a drawing application, or a Web browser application. When the user selects printing in the menu on the application's screen, a setting screen for a printer driver installed in the client device 1 is displayed. This setting screen shows widgets for individual items such as selection of printer, number of copies, scaling factor, whether to print on two sides or one side, whether to print multiple pages into one page, whether to perform monochrome printing or color printing, and selection of paper tray. The user makes desired settings on this screen.

Paper Tray on the printer driver setting screen indicates the source from which to supply paper. One of the accommodating unit 37 and the manual feed unit 38 is selected as a paper tray. If multiple accommodating units 37 or multiple manual feed units 38 exist, one of the multiple accommodating units 37 or multiple manual feed units 38 is selected. Items such as type of paper, size of paper, and kind of paper are set in advance for the accommodating unit 37. When the accommodating unit 37 is selected as a paper tray, preset values for the selected accommodating unit 37 are applied. Selecting the manual feed unit 38 as a paper tray activates the widgets used to set items such as type of paper, size of paper, and kind of paper.

Example types of paper include plain paper, envelope, postcard, label, and heavy paper. When plain paper is selected as a type of paper, for example, a widget used to select paper size (for example, A3, A4, B4, or B5 size based on JIS standards), or a widget used to select the kind of paper (for example, basis weight, paper thickness, or paper color) is displayed. When envelope is selected as a type of paper, for example, a widget for selecting paper size (for example, long type 3 or square type 3), or a widget for selecting the kind of paper (for example, weight of envelope or paper color) is displayed. Hereinafter, information indicating items such as type of paper, size of paper, and kind of paper will be referred to as print setting information. If type of paper included in print setting information indicates one type of special paper (envelope, postcard, label, or heavy paper), the controller 11 executes the guide screen display process.

The guide screen is a screen that shows information related to supply of special paper. There are two kinds of guide screens: a first guide screen and a second guide screen. The first guide screen is a guide screen displayed on the display device 14 of the client device 1 that is running in the desktop mode (the mode in which operations using a mouse and a keyboard are performed). By contrast, the second guide screen is a guide screen displayed on the display 24 of the portable terminal 2, the display 34 of the printer 3, and the display device 14 of the client device 1 that is running in the tablet mode. That is, the second guide screen is a guide screen displayed on a device that is operated by using a touch panel. The memory 12 stores guide screen information representing each of these guide screens. The guide screen information supplied by the supply section 101 (see FIG. 5) is guide screen information representing the second guide screen.

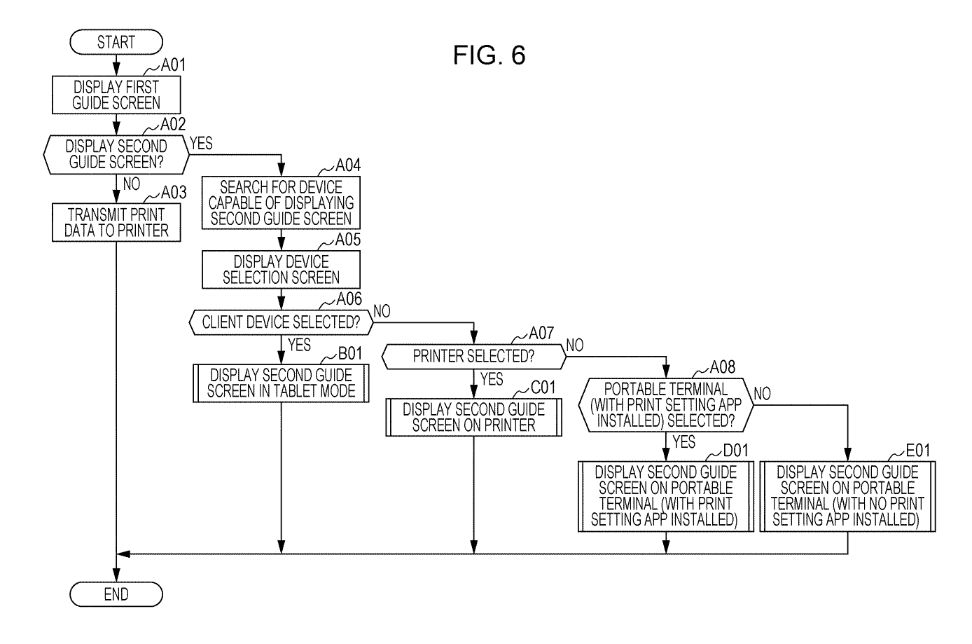

FIG. 6 is a flowchart of a guide screen display process.

### Step A01

The controller 11 causes the display device 14 to display the first guide screen.

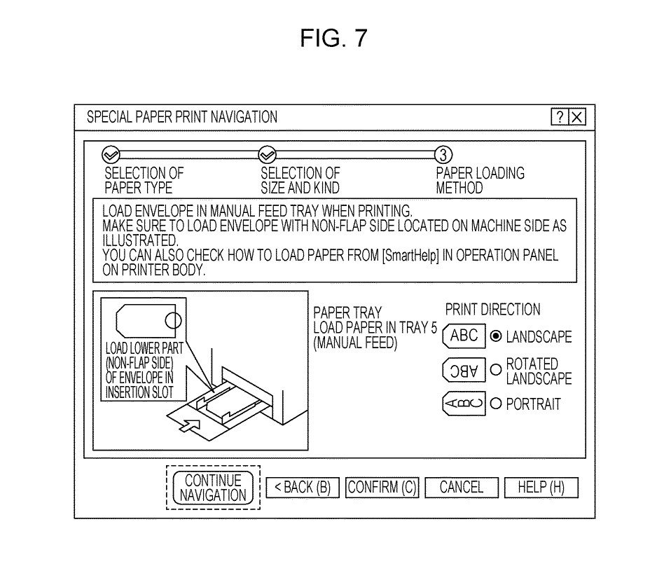

FIG. 7 illustrates the first guide screen. FIG. 7 illustrates an example of a screen displayed when envelope is selected as a type of paper. The first guide screen depicts the manual feed unit 38 in which an envelope is placed, with the orientation (portrait/landscape or front/back) in which to place the envelope being indicated by text and illustration.

### Step A02

The controller 11 determines whether an instruction to display the second guide screen has been received. Specifically, this determination is made as follows. The first guide screen (see FIG. 7) is provided with a “Continue Navigation” button and a “Confirm” button. The “Continue Navigation” button is a button used to display the second guide screen. When the user operates this button, the controller 11 determines that an instruction to display the second guide screen has been received (step A02: YES), and the controller 11 proceeds to step A04. The “Confirm” button is a button for causing a print to be executed without displaying the second guide screen. When the user operates this button, the controller 11 determines that an instruction to display the second guide screen has not been received (step A02: NO), and the controller 11 proceeds to step A03.

### Step A03

The controller 11 transmits print data to the printer 3. Specifically, the controller 11 converts data created by an application (such as a document-editing application, a drawing application, or a Web browser application) into print data written in page description language (PDL) format, and transmits the resulting print data to the printer 3. The printer 3 converts the received print data into raster data, and prints an image represented by this raster data on a medium.

### Step A04

The controller 11 searches for a device capable of displaying the second guide screen. Specifically, the controller 11 acquires functional information about the client device 1, the printer 3, and the portable terminal 2. The functional information indicates, for example, the size of the display surface, the presence/absence of a print setting application installed in the device (in the case of the portable terminal 2), the presence/absence of the tablet mode (in the case of the client device 1), or portability/non-portability (in the case of the client device 1). The print setting application is an application for displaying a simple setting screen, which has a part of the function of the printer driver setting screen, on a portable terminal. Portability/non-portability refers to whether it is possible to switch the client device 1 to the tablet mode, and separate the display device 14 from the body of the client device 1 to cause the display device 14 to function as a tablet PC. If the client device 1 is of a notebook type, depending on its size or weight, the client device 1 provides a portability equivalent to that of a tablet PC even when the display device 14 is not separated from the body. In such a case as well, the display device 14 is classified as a device capable of functioning as a tablet PC.

Functional information about the client device 1 is acquired from the memory 12 of the client device 1. Functional information about each of the printer 3 and the portable terminal 2 may be acquired as necessary through communication with the printer 3 and the portable terminal 2, or may be stored in the client device 1 in advance. The printer whose functional information is acquired at this time is the printer selected on the printer driver setting screen. This printer may be, for example, a printer that is preset as a normally used printer, or a printer selected by the user. The portable terminal whose functional information is acquired at this time is the portable terminal connected to a wireless LAN.

For each of devices whose functional information has been acquired, the controller 11 determines, based on the functional information, whether the device is capable of displaying the second guide screen. As for the size of the display surface, a threshold size necessary for display of the guide screen is set in advance. A device with a size of display surface equal to or greater than this threshold is determined to be a device capable of displaying the second guide screen. As for the client device 1, the client device 1 is determined to be a device capable of displaying the second guide screen if the device has a tablet mode and is portable.

### Step A05

The controller 11 causes the display device 14 to display a device selection screen. The device selection screen is a screen that shows a list of devices capable of displaying the second guide screen.

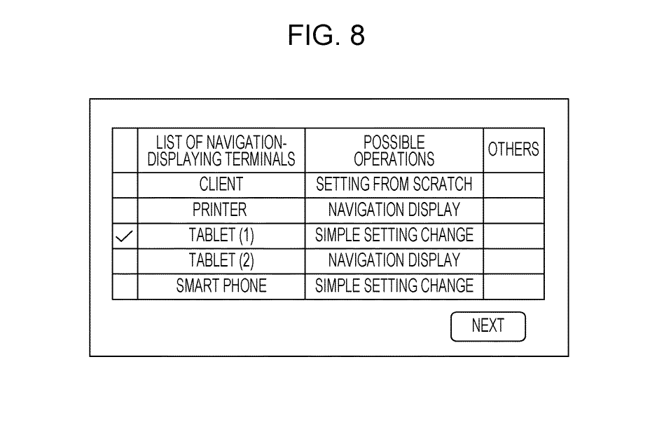

FIG. 8 illustrates the device selection screen. In FIG. 8, “Client” indicates the client device 1. “Printer” indicates the printer 3. Tablet (1), Tablet (2), and Smart Phone each indicate the portable terminal 2. “Setting from Scratch” in the “Possible Operations” field means that a setting screen equivalent in function to the printer driver setting screen is displayed in addition to the second guide screen. “Navigation Display” means that only the second guide screen is displayed. “Simple Setting Change” means that the device is installed with a print setting application for displaying, in addition to the second guide screen, a simple setting screen that has a part of the function of the printer driver setting screen. The user selects a desired device on the device selection screen, and operates the “Next” button. When the “Next” button is operated, the controller 11 proceeds to step A06.

### Step A06

The controller 11 determines whether the client device (“Client” in FIG. 8) has been selected. If the client device 1 has been selected (step A06: YES), the controller 11 proceeds to step B01. If the client device 1 has not been selected (step A06: NO), the controller 11 proceeds to step A07.

### Step B01

The controller 11 causes the second guide screen to be displayed on the client device 1 running in the tablet mode. This step will be described in detail later.

### Step A07

The controller 11 determines whether the printer 3 (“Printer” in FIG. 8) has been selected. If the printer 3 has been selected (step A07: YES), the controller 11 proceeds to step C01. If the printer 3 has not been selected (step A07: NO), the controller 11 proceeds to step A08.

### Step C01

The controller 11 causes the second guide screen to be displayed on the printer 3. This step will be described in detail later.

### Step A08

The controller 11 determines whether the portable terminal 2 (with a printer setting app installed) (“Tablet (1)” or “Smart Phone” in FIG. 8) has been selected. If the portable terminal 2 (with a printer setting app installed) has been selected (step A08: YES), the controller 11 proceeds to step D01. If the portable terminal 2 (with a printer setting app installed) has not been selected (step A08: NO), the controller 11 proceeds to step E01.

### Step D01

The controller 11 causes the second guide screen to be displayed on the portable terminal 2 (with a printer setting app installed). This step will be described in detail later.

### Step E01

The controller 11 causes the second guide screen to be displayed on the portable terminal 2 (with no printer setting app installed) (“Tablet 2” in FIG. 8). This step will be described in detail later.

Next, steps B01, C01, D01, and E01 mentioned above will be described in detail with reference to a sequence diagram also including processes executed by devices operating in conjunction with the client device. For ease of understanding, step E01 will be described first below.

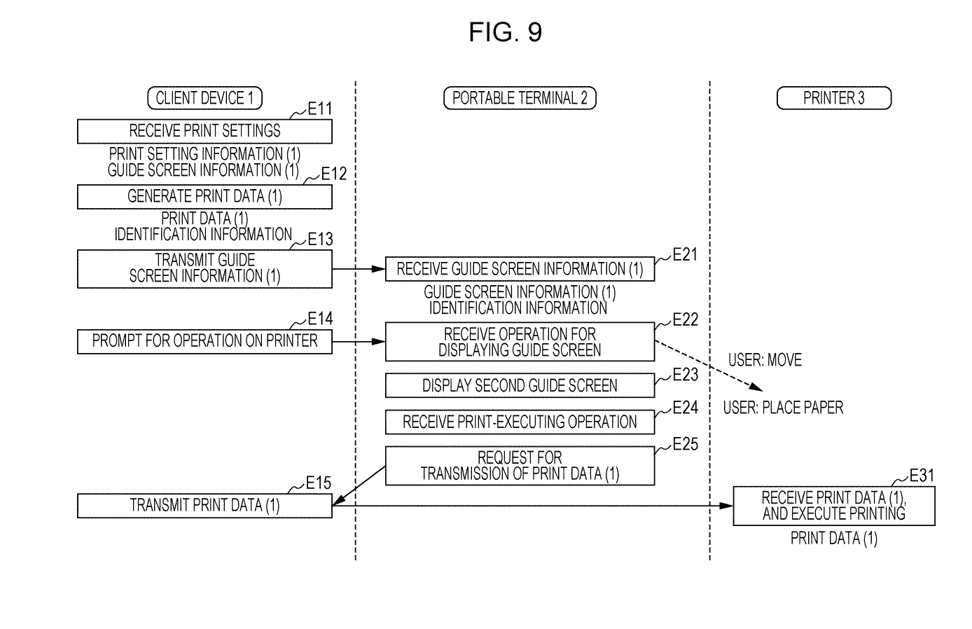

FIG. 9 is a sequence diagram of a first example of step E01.

### Step E11

The controller 11 of the client device 1 receives print settings from the printer driver setting screen, and generates print setting information (1) representing details of the print settings. Further, the controller 11 reads, from the memory 12, guide screen information (1) representing the second guide screen corresponding to the type of paper that has been set.

### Step E12

The controller 11 of the client device 1 generates print data (1) in PDL format based on data created by an application and the print setting information (1), and spools the print data (1). The controller 11 also generates identification information. The identification information includes, for example, one or more of the followings: a unique identifier for each print data, a user identifier, and a file name of print data. The unique identifier for each print data may be, for example, the time of creation of print data, or a string of characters or numerals generated in a regular or random manner.

### Step E13

The controller 11 of the client device 1 transmits the guide screen information (1) and the identification information to the portable terminal 2.

### Step E21

The controller 21 of the portable terminal 2 receives the guide screen information (1) and the identification information.

### Step E14

The controller 11 of the client device 1 causes the display device 14 to display a message that prompts for an operation (placement of paper) to be performed on the printer 3. When the user sees this message, the user moves to the location of the printer 3 while carrying the portable terminal 2.

### Step E22

The controller 21 of the portable terminal 2 receives an operation for displaying the second guide screen. For example, the controller 21 causes the display 24 to display a list of identification information corresponding to the guide screen information (1) on which no operation has yet been performed. When the user selects any one of the pieces of identification information displayed, the controller 21 causes the display 24 to display a message “Display paper navigation?”, and a “Yes” button and a “No” button. If the “Yes” button is operated, the controller 21 proceeds to step E23.

### Step E23

The controller 21 of the portable terminal 2 causes the display 24 to display the second guide screen based on the guide screen information (1). The second guide screen displayed at this time corresponds to the first guide screen (see FIG. 7) from which the “Continue Navigation” button is removed. The user places paper in accordance with information on the second guide screen.

### Step E24

The controller 21 of the portable terminal 2 receives a print-executing operation. For example, if the “Confirm” button on the second guide screen is operated, the controller 21 proceeds to step E25.

### Step E25

The controller 21 of the portable terminal 2 requests the client device 1 to transmit the print data (1) to the printer 3.

### Step E15

The controller 11 of the client device 1 transmits the print data (1) being spooled to the printer 3.

### Step E31

The controller 31 of the printer 3 receives the print data (1), and executes printing.

The above completes the first example of step E01.

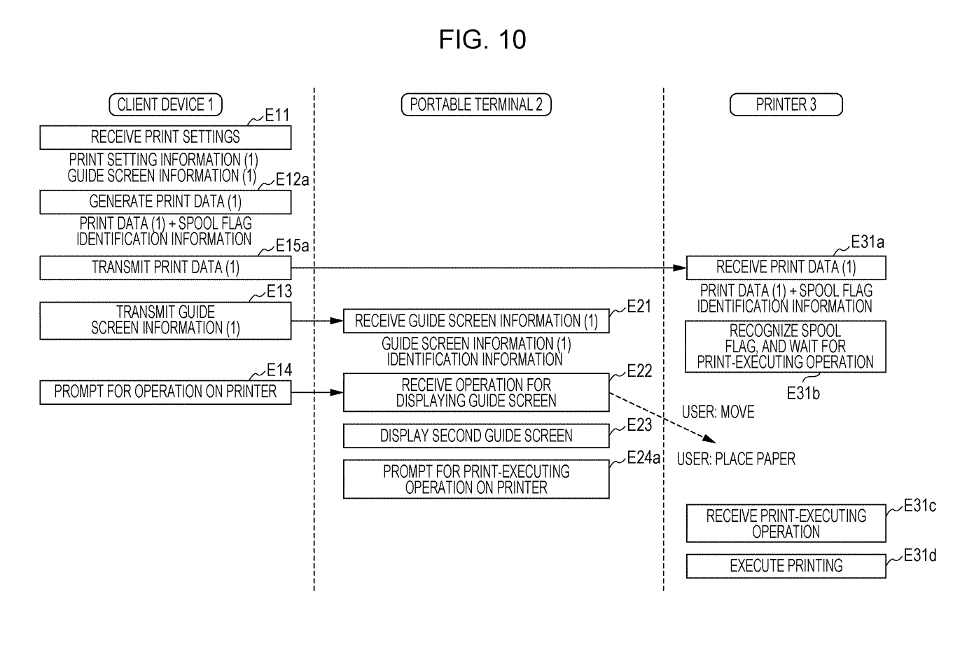

FIG. 10 is a sequence diagram of a second example of step E01. As opposed to the first example of step E01 in which print data is spooled in the client device 1, in the second example of step E01, print data is spooled in the printer 3. Steps with the same step numbers as those in the first example of step E01 are identical to the corresponding steps in the first example of step E01, and hence a description of those steps will be omitted.

### Step E12a

The controller 11 of the client device 1 generates print data (1) in PDL format based on data created by an application and print setting information (1). The controller 11 adds a spool flag to the print data (1). The spool flag is a flag indicating that the corresponding print data (1) is to be spooled in the printer 3. The controller 11 also generates identification information.

### Step E15a

The controller 11 of the client device 1 transmits the print data (1) and the identification information to the printer 3.

### Step E31a

The controller 31 of the printer 3 receives the print data (1) and the identification information.

### Step E31b

The controller 31 of the printer 3 recognizes the spool flag, and spools the print data (1). The controller 31 waits until a print-executing operation is received.

### Step E24a

The controller 21 of the portable terminal 2 causes the display 24 to display a message that prompts for a print-executing operation to be performed on the printer 3. When the user sees this message, the user performs a print-executing operation on the printer 3.

### Step E31c

The controller 31 of the printer 3 receives a print-executing operation.

### Step E31d

The controller 31 of the printer 3 executes printing based on the print data (1) being spooled.

The above completes the second example of step E01.

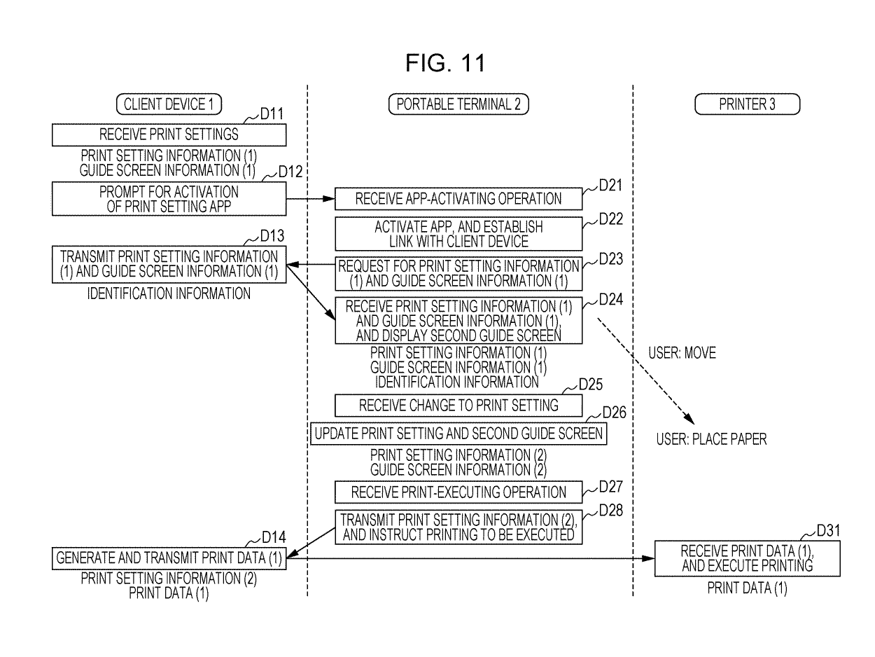

FIG. 11 is a sequence diagram of a first example of step D01.

### Step D11

The controller 11 of the client device 1 receives print settings from the printer driver setting screen, and generates print setting information (1) representing details of the print settings. Further, the controller 11 reads, from the memory 12, guide screen information (1) representing the second guide screen corresponding to the type of paper that has been set.

### Step D12

The controller 11 of the client device 1 causes the display device 14 to display a message prompting for activation of the print setting application on the portable terminal 2. When the user sees this message, the user performs an operation for activating the print setting application on the portable terminal 2.

### Step D21

The controller 21 of the portable terminal 2 receives the operation for activating the print setting application.

### Step D22

The controller 21 of the portable terminal 2 activates the print setting application. Further, the controller 21 establishes a wireless communication link with the client device 1.

### Step D23

The controller 21 of the portable terminal 2 requests the client device 1 for the print setting information (1) and the guide screen information (1).

### Step D13

The controller 11 of the client device 1 generates identification information, and transmits the print setting information (1), the guide screen information (1), and the identification information to the portable terminal 2.

### Step D24

The controller 21 of the portable terminal 2 receives the print setting information (1), the guide screen information (1), and the identification information, and causes the display 24 to display a list of identification information corresponding to the guide screen information (1) on which no operation has yet been performed. When the user selects any one of the pieces of identification information displayed, the controller 21 causes the display 24 to display a message “Display paper navigation?”, and a “Yes” button and a “No” button. If the “Yes” button is operated, the controller 21 causes the display 24 to display the second guide screen based on the guide screen information (1). The user moves to the location of the printer 3 while carrying the portable terminal 2, and places paper in accordance with information on the second guide screen.

### Step D25

The controller 21 of the portable terminal 2 receives a change to a print setting on the simple setting screen for the print setting application.

### Step D26

The controller 21 of the portable terminal 2 updates the print setting and the second guide screen in accordance with the change to the print setting made on the simple setting screen. The controller 21 updates the print setting information (1) to print setting information (2), and updates the guide screen information (1) to guide screen information (2). For example, when the type of paper or the size of paper is changed, the second guide screen corresponding to the changed type of paper or the changed size of paper is displayed.

### Step D27

The controller 21 of the portable terminal 2 receives a print-executing operation.

### Step D28

The controller 21 of the portable terminal 2 transmits the print setting information (2) to the client device 1, and instructs the client device 1 to execute printing.

### Step D14

The controller 11 of the client device 1 generates print data (1) in PDL format based on data created by an application and the print setting information (2), and transmits the print data (1) to the printer 3.

### Step D31

The controller 31 of the printer 3 receives the print data (1), and executes printing.

The above completes the first example of step D01.

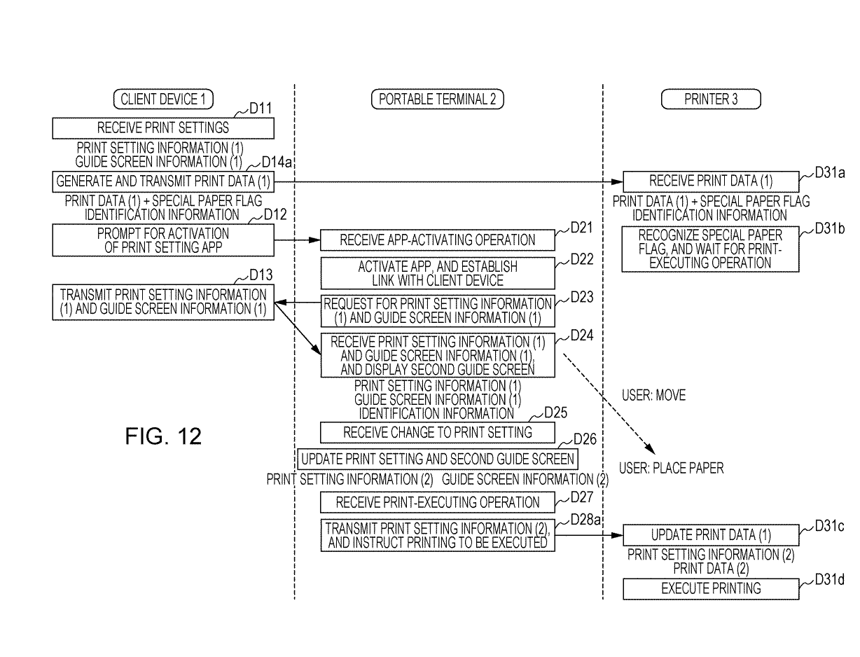

FIG. 12 is a sequence diagram of a second example of step D01. As opposed to the first example of step D01 in which print data is generated after a print-executing operation is made on the portable terminal 2, in the second example of step D01, print data is generated after print settings are made on the client device 1, and the generated print data is spooled in the printer 3. Steps with the same step numbers as those in the first example of step D01 are identical to the corresponding steps in the first example of step D01, and hence a description of those steps will be omitted.

### Step D14a

The controller 11 of the client device 1 generates print data (1) in PDL format based on data created by an application and print setting information (1). The controller 11 adds a special paper flag to the print data (1). The special paper flag is a flag indicating that one type of special paper has been selected as a type of paper. The controller 11 also generates identification information. The controller 11 transmits the print data (1) and the identification information to the printer 3.

### Step D31a

The controller 31 of the printer 3 receives the print data (1) and the identification information.

### Step D31b

The controller 31 of the printer 3 recognizes the special paper flag, and spools the print data (1). The controller 31 waits until a print-executing operation is received.

### Step D28a

The controller 21 of the portable terminal 2 transmits print setting information (2) to the printer 3, and instructs the printer 3 to execute printing.

### Step D31c

The controller 31 of the printer 3 receives the print setting information (2), and based on the print setting information (2), updates the print data (1) being spooled to print data (2).

### Step D31d

The controller 31 of the printer 3 executes printing based on the print data (2).

The above completes the second example of step D01.

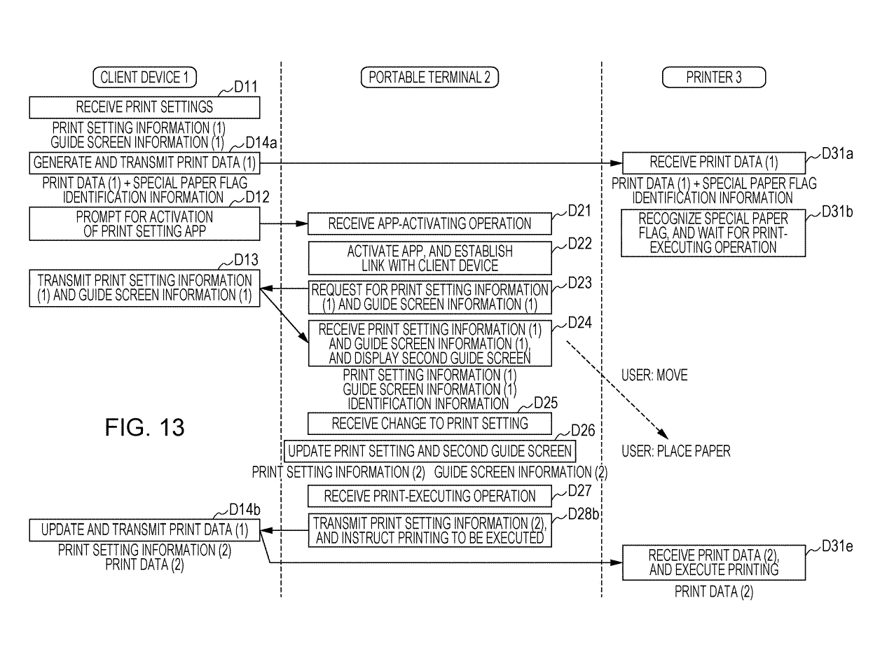

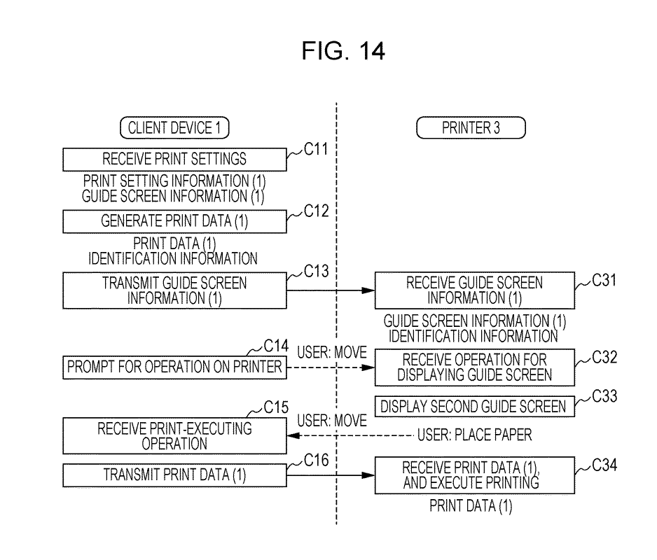

FIG. 13 is a sequence diagram of a third example of step D01. As opposed to the second example of step D01 in which print data is updated by the printer 3 in accordance with a change to a print setting made on the portable terminal 2, in the third example of step D01, print data is updated by the client device 1. Steps with the same step numbers as those in the second example of step D01 are identical to the corresponding steps in the second example of step D01, and hence a description of those steps will be omitted.

### Step D28b

The controller 21 of the portable terminal 2 transmits print setting information (2) to the client device 1, and instructs the printer 3 to execute printing.

### Step D14b

The controller 31 of the printer 3 receives the print setting information (2), and updates print data (1) to print data (2) based on the print setting information (2), and transmits the print data (2) to the printer 3.

### Step D31e

The controller 31 of the printer 3 receives the print data (2), and executes printing. The controller 31 discards the print data (1) being spooled.

The above completes the third example of step D01.

FIG. 14 is a sequence diagram of a third example of step C01.

### Step C11

The controller 11 of the client device 1 receives print settings from the printer driver setting screen, and generates print setting information (1) representing details of the print settings. Further, the controller 11 reads, from the memory 12, guide screen information (1) representing the second guide screen corresponding to the type of paper that has been set.

### Step C12

The controller 11 of the client device 1 generates print data (1) in PDL format based on data created by an application and the print setting information (1), and spools the print data (1). The controller 11 also generates identification information.

### Step C13

The controller 11 of the client device 1 transmits the guide screen information (1) and the identification information to the printer 3.

### Step C31

The controller 31 of the printer 3 receives the guide screen information (1) and the identification information.

### Step C14

The controller 11 of the client device 1 causes the display device 14 to display a message prompting for an operation (placement of paper) to be performed on the printer 3. When the user sees this message, the user moves to the location of the printer 3.

### Step C32

The controller 31 of the printer 3 receives an operation for displaying the second guide screen. For example, the controller 31 causes the display 34 to display a list of identification information corresponding to the guide screen information (1) on which no operation has yet been performed. When the user selects any one of the pieces of identification information displayed, the controller 31 causes the display 34 to display a message “Display paper navigation?”, and a “Yes” button and a “No” button. If the “Yes” button is operated, the controller 31 proceeds to step C33.

### Step C33

The controller 31 of the printer 3 causes the display 34 to display the second guide screen based on the guide screen information (1). The user places paper in accordance with information on the second guide screen. After placing paper, the user moves to the location of the client device 1.

### Step C15

The controller 11 of the printer 3 receives a print-executing operation.

### Step C16

The controller 11 of the client device 1 transmits the print data (1) being spooled to the printer 3.

### Step C34

The controller 31 of the printer 3 receives the print data (1), and executes printing.

The above completes the first example of step C01.

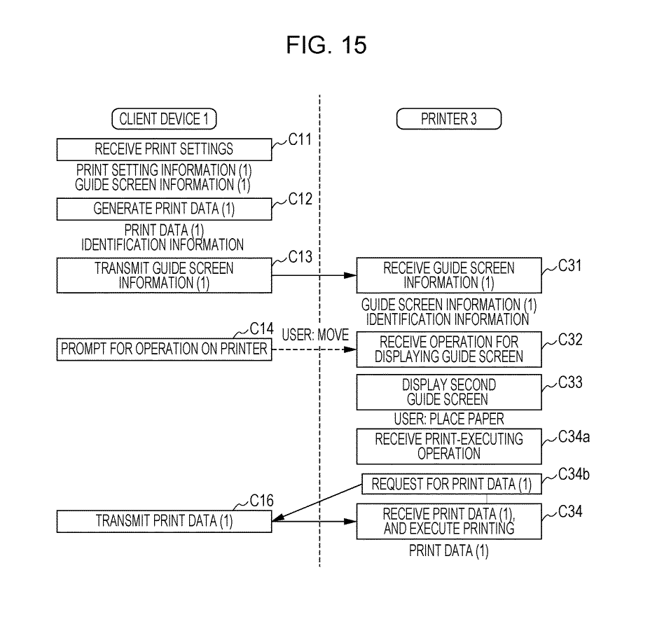

FIG. 15 is a sequence diagram of a second example of step C01. As opposed to the first example of step C01 in which a print-executing operation is received by the client device 1, in the second example of step C01, a print-executing operation is received by the printer 3. Steps with the same step numbers as those in the first example of step C01 are identical to the corresponding steps in the first example of step C01, and hence a description of those steps will be omitted.

### Step C34a

The controller 31 of the printer 3 receives a print-executing operation.

### Step C34b

The controller 31 of the printer 3 requests the client device 1 for print data (1).

The above completes the second example of step C01.

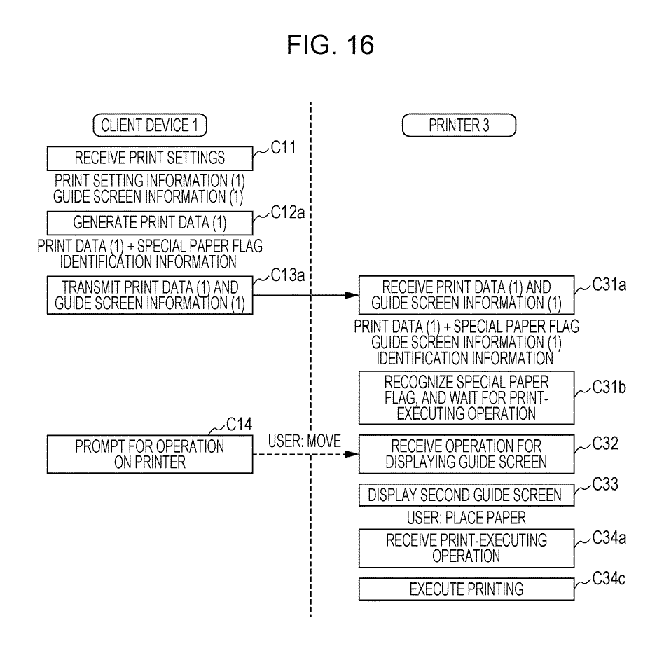

FIG. 16 is a sequence diagram of a third example of step C01. As opposed to the first and second examples of step C01 in which print data is spooled in the client device 1, in the third example of step C01, print data is spooled in the printer 3. Steps with the same step numbers as those in the first and second examples of step C01 are identical to the corresponding steps in the first and second examples of step C01, and hence a description of those steps will be omitted.

### Step C12a

The controller 11 of the client device 1 generates print data (1) in PDL format based on data created by an application and print setting information (1). The controller 11 adds a special paper flag to the print data (1). The controller 11 also generates identification information.

### Step C13a

The controller 11 transmits the print data (1) and the guide screen information (1) to the printer 3.

### Step C31a

The controller 31 of the printer 3 receives the print data (1), the guide screen information (1), and the identification information.

### Step C31b

The controller 31 of the printer 3 recognizes the special paper flag, and spools the print data (1). The controller 31 waits until a print-executing operation is received.

### Step C34c

The controller 31 of the printer 3 executes printing based on the print data (1) being spooled.

The above completes the third example of step C01.

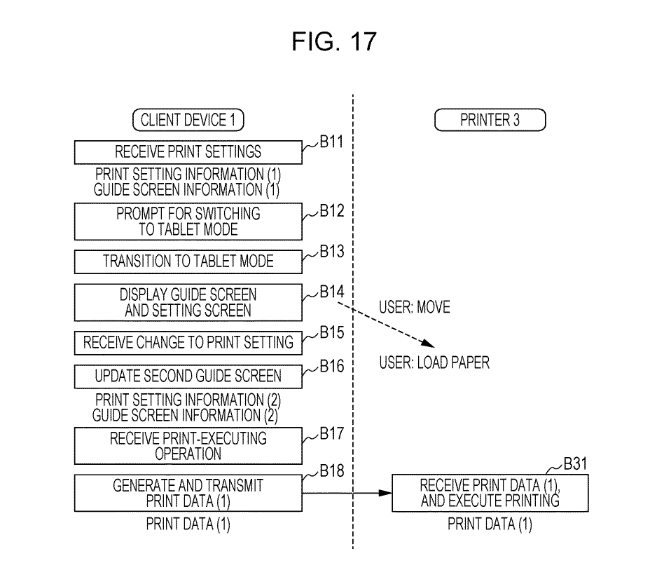

FIG. 17 is a sequence diagram of an example of step B01.

### Step B11

The controller 11 of the client device 1 receives print settings from the printer driver setting screen, and generates print setting information (1) representing details of the print settings. Further, the controller 11 reads, from the memory 12, guide screen information (1) representing the second guide screen corresponding to the type of paper that has been set.

### Step B12

The controller 11 of the client device causes the display device 14 to display a message that prompts for switching to the tablet mode. When the user sees this message, the user performs an operation for switching the client device 1 to the tablet mode.

### Step B13

The controller 11 of the client device 1 causes the client device 1 to transition to the tablet mode.

### Step B14

The controller 11 of the client device 1 causes the second guide screen based on the guide screen information (1), and the printer driver setting screen to be displayed.

### Step B15

The controller 11 of the client device 1 receives a change to a print setting from the printer driver setting screen.

### Step B16

The controller 11 of the client device 1 updates the second guide screen in accordance with the changed print setting. The controller 11 updates the print setting information (1) to print setting information (2), and updates the guide screen information (1) to guide screen information (2).

### Step B17

The controller 11 of the client device 1 receives a print-executing operation.

### Step B18

The controller 11 of the client device 1 generates print data (1) in PDL format based on data created by an application and the print setting information (2), and transmits the print data (1) to the printer 3.

### Step B31

The controller 31 of the printer 3 receives the print data (1), and executes printing.

The above completes the example of step B01.

According to the exemplary embodiment, a guide screen related to supply of paper to a printer is displayed on a specified device. Further, according to the exemplary embodiment, the device on which to display a guide screen is selected by the user. According to the first to third examples of step D01 and the example of step B01, when a change is made to a print setting, a guide screen corresponding to the changed setting is displayed. According to the exemplary embodiment, a guide screen is displayed on a device including a touch panel. Accordingly, a guide screen is displayed on a tablet PC, a smart phone, and a printer including a touch panel. Further, if the client device includes a desktop mode and a tablet mode, a guide screen is displayed in the tablet mode.

The above-mentioned exemplary embodiment may be modified as modifications described below. Further, multiple modifications may be combined.

### Modification 1

The above-mentioned exemplary embodiment is directed to a case in which the client device 1 displays the device selection screen, and the second guide screen is displayed on a device that is selected by the user on the device selection screen. Alternatively, the configuration of the application for the guide screen display process may be such that one of the client device 1, the printer 3, and the portable terminal 2 is set in advance as a device on which to display the second guide screen. Further, this setting may be changed by a user's operation.

### Modification 2

The configuration of the application for the guide screen display process may be such that a recommended device on which to display the second guide screen is presented on the device selection screen. For example, the controller 11 of the client device 1 may, for each of devices (the client device 1, the printer 3, and the portable terminal 2), make an evaluation as to whether the device is a suitable device on which to display the second guide screen, based on information such as the size of the display surface, the presence/absence of a print setting application installed in the device (in the case of the portable terminal 2), and the history of use of the device as a device on which the second guide screen is displayed. Then, the controller 11 of the client device 1 may present, on the device selection screen, information such as the device with the highest evaluation or the ranking of evaluation of individual devices.

### Modification 3

Guide screen information appropriate for the device (the client device 1, the printer 3, or the portable terminal 2) on which to display the second guide screen may be used. For example, in one exemplary configuration, multiple pieces of guide screen information created for each individual size of display surface are stored in the client device 1 in advance, and guide screen information appropriate for the size of the display surface of the device on which to display the second guide screen is read and supplied. In another exemplary configuration, the controller 11 of the client device 1 changes the number of pixels in the guide screen information in accordance with the size of the display surface, and supplies the changed guide screen information.

### Modification 4

Although the above-mentioned exemplary embodiment is directed to a case in which the second guide screen is a guide screen displayed on a device that is operated by using a touch panel, the second guide screen may be a guide screen displayed on a device that is operated by using a mouse and a keyboard. In this case, the client device 1 may not include the tablet mode, and the printer 3 or the portable terminal 2 may not include a touch panel.

### Modification 5

Although the above-mentioned exemplary embodiment is directed to a case in which the function of the guide screen display process is implemented by software, a part or whole of this function may be implemented by a hardware circuit. This software may be provided by being recorded on a computer readable recording medium, such as a magnetic recording medium, an optical recording medium, or a semiconductor memory, and the software may be read from this recording medium and installed. Further, this software may be provided via telecommunication line.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A client device comprising:
a controller configured to act as
a supply section that supplies guide screen information to a specified device in response to selection of a specific type of paper, the guide screen information representing a guide screen related to supply of the selected paper to a printer,
a receiving section that displays at least one device candidate together with an indication of at least one operation that can be executed on the at least one device candidate, and receives a selection of a device, from among the at least one device candidate, to which the guide screen information is supplied; and
a transmitting section that transmits print data to the printer,
wherein the supply section supplies the guide screen information to the device selected by using the receiving section.

2. (canceled)

3. The client device according to claim 8, further comprising:
a display that, when the client device is selected by using the receiving section, displays a guide screen based on the guide screen information, and a print setting screen that receives a change to a print setting; and
an updating section that updates the guide screen in accordance with the print setting changed on the print setting screen.

4. The client device according to claim 1,
wherein the guide screen represented by the guide screen information comprises a screen used to perform an operation using a touch panel.

5. (canceled)

6. A non-transitory computer readable medium storing a program causing a computer to execute a process, the process comprising:
supplying guide screen information to a specified device in response to selection of a specific type of paper, the guide screen information representing a guide screen related to supply of the selected paper to a printer;
causing to be displayed at least one device candidate together with an indication of at least one operation that can be executed on the at least one device candidate, and receiving a selection of a device, from among the at least one device candidate, to which the guide screen information is supplied; and
transmitting print data to the printer,
wherein the supplying supplies the guide screen information to the device selected during the receiving.

7. (canceled)

8. The client device according to claim 1,
wherein the at least one device candidate includes a portable device, a printer, and the client device if the client device has a tablet mode and/or is portable.

9. The client device according to claim 1,
wherein the at least one operation includes changing a print setting.

10. The non-transitory computer readable medium according to claim 6,
wherein the at least one operation includes changing a print setting.
